(19) United States
(12) Patent Application Publication
(10) Pub. No.: US 2021/0276448 A1
(43) Pub. Date: Sep. 9, 2021

(54) BATTERY EXCHANGE PROGRAM USING UNIVERSAL RECHARGEABLE BATTERIES, FITTING BATTERY CASES, BATTERY PACKS, MINI RACK AND RACK SYSTEMS ALONG WITH GPS TRACKING FOR BATTERY EXCHANGE STATIONS

(71) Applicant: Mohanadas BALASINGHAM, New South Wales (AU)

(72) Inventor: Mohanadas BALASINGHAM, New South Wales (AU)

(21) Appl. No.: 16/627,387

(22) PCT Filed: May 3, 2018
(86) PCT No.: PCT/IB2018/053086

§ 371 Date: Dec. 30, 2019

Related U.S. Application Data
(60) Provisional application No. 62/538,696, filed on Jul. 29, 2017.

(51) Int. Cl. B60L 53/80; B60K 1/04; B60L 53/66

(52) U.S. Cl. CPC B60L 53/80; B60K 1/04; B60K 2001/0494; B60K 2001/0411; B60K 2001/0483; B60L 53/665

(57) ABSTRACT

This invention relates to a rechargeable battery system. The invention, particularly relates to a battery system that comprises at least one battery pack and a network of charging stations. The battery pack is typically provided in cars, and other all other modalities of transport including vans, trucks, buses, trains, ships, planes, etc. The charging stations are provided at strategic locations for ease and convenience. The user of the vehicle can either visit the charging stations or Mobile charging stations can come to a particular location where the customer determines by use of a special Apps (mobile or web-based) to either replace the discharged battery packs with fully charged battery packs, or the user can recharge the battery packs at the charging stations. The battery packs can have different ratings, but the outer casing of the battery packs of different rating will have a standard size, which provides the battery packs a modular configuration. The racks that holds the battery packs are universal and unique that multitudes of these racks can be mounted any/solar charging stations. Similarly multitudes of racks can be mounted to any vehicle as per the needs of the vehicles. The batteries are designed in such a unique way that it is easy for anyone or a robot to change the batteries. This make the battery exchange program unique and stand out to other inventions.

### CROSS REFERENCE TO RELATED APPLICATIONS

Not applicable

### FEDERALLY SPONSORED RESEARCH AND DEVELOPMENT

Not applicable.

### MICROFICHE

Not applicable

### FIELD OF THE INVENTION

The present invention generally relates to the field of batteries. In particular, the present invention relates to a rechargeable battery system having recharge stations which are provided at strategic locations.

### BACKGROUND OF THE INVENTION

Hybrid vehicles are known in the art that operate on more than one fuel source, typically fossil fuels and an electric battery. The typical fuel sources include petrol, diesel, compressed natural gas, batteries, and combination thereof to drive the engine of the vehicle. Typical hybrid or electric vehicles developed in the art use an electric motor or a combination of electric motors and a fossil fuel to provide the drive to the wheels of the vehicle. These hybrid or electric vehicles which employ the use of electric power typically include battery systems, which has one or more batteries to store electricity. When the vehicle is mobile, an alternator in the vehicle operates use the motion of the wheels to charge these batteries. However, for fully battery-operated vehicles, this recharging does not suffice, and the batteries need to be changed or recharged externally via a static or an electric outlet.

To this end, U.S. Pat. No. 6,310,464 discloses an apparatus for charging the battery of an electric car. The apparatus comprises a battery charge controller, a battery charger, and a battery. The charge controller being capable of detecting the charge status of the battery, and upon detecting an under-charge condition of initializing, at any given time, a charging process wherein the battery is charged an expected charge amount which is dependant on the degree of under-charge initially detected by the charge controller. The charge controller upon termination of the charging process detects the actual charge amount and compares that amount to the expected charge amount and calculates a difference value. If the difference value exceeds a predetermined reference value, the controller charges the battery pack an additional predetermined amount.

U.S. Pat. No. 5,539,296A discloses a battery charging method and system which are applicable to battery-powered vehicles. According to the charging system of the invention, there is provided a primary charger including a primary winding which is connectable with a source of charging alternating current at a charging station. There are also provided at least two secondary chargers each connected with a battery on each vehicle and including a secondary winding having a number of winding turns which is different from that of the winding of the other secondary charger. Transfer of electrical energy from the primary charger to the secondary chargers is accomplished by inductively coupling the primary winding with any selected one of the secondary windings, as a result of which a voltage, the magnitude of which is dependent on the turns ratio between the primary and secondary windings, is produced across the selected secondary winding.

U.S. Pat. No. 5,049,802A discloses automated charging systems for vehicles having rechargeable batteries that are in common use today. Such systems typically have exposed contacts or the need for additional circuitry to move the contacts. The subject system includes circuitry which allows the charge receiving member to be only connected to the battery during charging. The charging system produces a charging signal in response to a low battery. A microprocessor receives the charging signal and responsively produces a “pulse” signal. A second transistor switch receives the “pulse” signal and responsively energizes a charging contactor coil. In response to the charging contactor coil being energized, contacts controllably block power from the battery to the motor and pass power from the receiving member to the battery.

However, a disadvantage associated with the aforementioned prior art documents is that none of the systems described in the prior art envisage a universal battery charging system that can be used to charge batteries of different ratings. Further, none of the conventional systems disclose the modular and swappable batteries which can be swapped at strategic locations, when charging the battery is not an option due to time constraints.

### BRIEF SUMMARY OF THE INVENTION

In view of the foregoing disadvantages inherent in the known systems for battery charging present in the prior art, the present invention provides a universal battery charging system, which automates the entire process and systems of providing facilities of battery charging wherever the customer can go around. As such, the general purpose of the present invention, which will be described subsequently in greater detail, is to provide a new and improved a universal battery charging system, which has all the advantages of the prior art and none of the disadvantages.

It is an object of the present disclosure to provide a battery system comprising a battery pack comprising a plurality of batteries; at least one charging station provided at strategic locations in a town; and at least one battery rack for supporting the battery pack and electrically connecting with the battery pack either for charging or discharging. In the battery system, for charging, the battery rack is provided at the charging station, and for discharging, the battery rack is provided at end application setup. In an embodiment, the end application setup is an electric car or a hybrid car.

It is another object of the present disclosure to provide a battery system further comprising an application module installable on at least one smart device of a user.

It is another object of the present disclosure to provide a battery system, wherein the charging station is configured to generate power via renewable sources of energy.

It is another object of the present disclosure to provide a battery system, wherein the charging stations further comprise at least one GPS module.

It is another object of the present disclosure to provide a battery system, wherein the application module is configured to allow the user to track the locations of the charging stations.

It is another object of the present disclosure to provide a battery system, wherein the application module is configured to facilitate electronic payment either via bank account or digital wallets.

It is another object of the present disclosure to provide a battery system, wherein the battery pack is ejectably mounted on the battery rack.

It is another object of the present disclosure to provide a battery system, wherein the ejection is facilitated either manually or remotely.

It is another object of the present disclosure to provide a battery system, wherein the charging stations include fully charged individual batteries or battery packs to be exchanged with discharged batteries at the end application setup.

It is another object of the present disclosure to provide a battery system, wherein the application module is configured to compute payment based on difference in charge levels of the exchanged battery packs.

It is another object of the present disclosure to provide a battery system, wherein the battery rack further comprises a battery management unit.

The present disclosure also envisages a method to operate the battery system.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 shows illustrates a block diagram of a battery system, in accordance with an embodiment of the present invention.

FIG. 2A through FIG. 2E illustrates isometric views of different components of the batter system of FIG. 1.

FIG. 3A to 3B illustrates different views of the universal battery module with tracks and FIG. 3C illustrates perspective view of the universal battery system.

FIG. 4A and FIG. 4B illustrate a block diagram of a method of operating the battery system, in accordance with an embodiment of the present invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention.

The present invention relates to a battery system with modular batteries which is usable in a multitude of applications, with one example being that of a vehicle. It is to be noted that the battery system of the present invention is described hereinafter as being used in vehicles. However, the application of the battery system is not limited to vehicles.

With the depletion of the fossil fuels happening rapidly, more and more countries are hatching out plans to make their automobile industry free from the usage of the fossil fuels by relying upon the use of electricity. It is estimated that these electric cars will run a lot cheaper than fossil fuels.

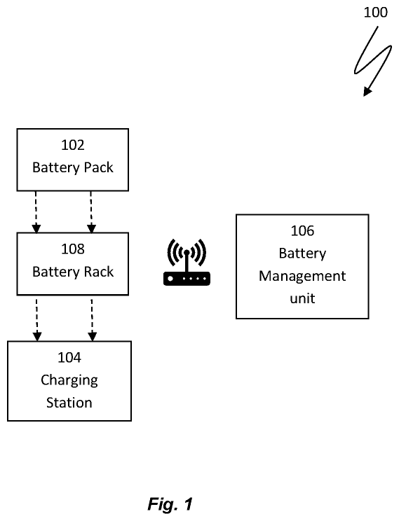

A battery system 100, in accordance with the present invention, is described with reference to FIG. 1, wherein FIG. 1 illustrates a block diagram of the battery system 100. The battery system 100 (hereinafter referred to as system 100) comprises two major elements, viz., at least one battery pack 102 and at least one charging station 104. In an embodiment, the charging stations 104 are solar power generation units or wind power generation units. Use of other renewable sources of energy as charging stations are well within the ambit of the present invention. In another embodiment, the charging station 104 is a conventional electric supply socket, wherein the electric supply is provided by the electricity grid.

In accordance with the present invention, the battery packs 102 are of various capacities ranging from 4 KwH, 5 KwH, 6 KwH, 8 KwH, 10 KwH, 12 KwH, and 15 Kwh. The voltage of the battery pack can be 48V DC or 96 V DC. In accordance with the present invention, the battery packs 102 are encased in a casing of one standard size. In accordance with one embodiment, the standard size is 60 cm×80 cm×15 cm.

The charging stations 104 are provided at strategic locations, which are easy and convenient for a user to access. For example, the charging stations 104 are provided near household garages, bus stops, market, gas stations, at regular intervals on highways and expressways, and so on. It is to be noted that the charging stations 104 are provided with a plurality of charged batteries for the battery pack 102, so that a user only needs to replace the discharged batteries with the charged ones. In another embodiment, the charging stations 104 have the provision that allows the user to charge their own batteries.

The system 100 further comprises a battery management unit 106 which is provided with a Wi-fi module. The Wi-fi module of the battery management unit 106 facilitates the online real-time monitoring of the battery pack 102 on smart devices such as laptops, smart phones, tablet, and so on. In an embodiment, the battery management unit 106 is provided with LEDs which indicate visually the charge in the battery packs 102. The number of the LEDs which are glowing indicate the amount of charge available in the battery packs 102. In another embodiment, the battery management unit 106 is provided with a display that displays the percentage of charge remaining in the battery pack 102.

The system 100 further comprises at least one battery rack 108. The battery racks 108 are secure frames configured to hold the batteries in place at end application setup, e.g., a car, van, bus, truck, train, boat, ship, airplane or any other electrical equipment. The battery racks 108 can also be provided at charging stations to facilitate the charging of the batteries. The battery rack 108 has a profile that complements the profile of the battery pack 102. The battery packs 102 are mountable on the battery racks 108. The battery packs 102 can be detached from the battery racks 108 either manually or remotely. In an embodiment, the battery rack 108 is provided with DIN rails for facilitating mounting and dismounting the battery pack 102 on the battery rack 108, much like the loading of a compact disc in a tray. In an embodiment, the battery pack 102 can be detached from the battery rack 108 via a key. The battery racks 108 that hold the battery packs 102 will have two or more electric contacts or terminals provided for connecting with and recharging the battery pack 102 [+ve terminal and −ve terminal]. In an embodiment, the terminals of the battery packs 102 [+ve and −ve terminals] will be on the bottom or side of the battery pack 102 and will engage with the corresponding terminal of the battery rack 108 securely. The battery pack 102 will get locked once secured to the battery rack 108 properly. In an embodiment, the battery pack 102 can be easily demounted by unlocking it with a key and pressing a lever on the battery rack 108 to dismount and easily pull out of the frame of the battery rack 108 via two the handles provided on the top side of the battery pack 102. The battery rack 108 is provided at the charging stations 104 as well as at the end application setup. In one example, the battery pack 102, once it is charged can be easily removed from the charging rack and can be mounted to the battery racks 108 provided in a bonnet of a vehicle. In one embodiment, one vehicle will have between one to several such racks to mount the battery packs 102 in the bonnet as well as other possible locations in the vehicle. In one example, a car can have up to six such battery packs 102 in the bonnet to give roughly 60 KwH of power. In another embodiment, the batteries in the battery pack 102 can provide a fixed amount of power, wherein for different kinds of application requiring different power ratings, one or more battery packs 102 maybe arranged in series or parallel for providing the desired power rating.

In another example, the vehicles are provided with attractive solar panels on the roof and bonnet area for acting as charging stations 104 for the vehicle, thereby charging the battery packs 102 on the go. In one example, at the charging stations 104, apart from providing the feature of charging the battery packs 102, it is possible to provide fully charged battery packs 102 to replace with the discharged battery packs 102. The entire process of replacing the fully charged battery packs 102 with the discharged battery packs 102 can be automated.

In an embodiment, the battery management unit 106 is provided in the vehicles and coupled with the infotainment systems of the vehicle. The battery management unit 106 will provide the charge in each battery pack 102 on the display of the vehicle infotainment system and indicate to the driver how long and how far they can drive with the current state of the battery packs 102.

In an embodiment, the charging stations 104 are provided with GPS modules. In an embodiment, the user of the system 100 will enter into a contract at the time of purchase of the vehicle that he or she is happy to enter into the battery exchange program facilitated by the system 100 of the present disclosure. The battery management unit 106 is provided with an application that provides the user with the locations of the various charging stations 104 in the vicinity of the user. The application will further include different modules to track the user's charging activities, payment receipts, credit/debit card details, digital wallet details, and the like. The user can also prepay before coming to the exchange station. The user can also apply for an account; the user can apply for an “Energy Card” similar to certain shopping cards and they can purchase the “current” from it. The application, that will be operable, either via smart devices such as laptops, smart phones, tablets and the like, will also be operable via the battery management unit 106 and displayable on the infotainment system of the vehicle. Once the user finds the nearest charging station 104 via the application, the charging station 104 can be configured to communicate the user regarding the availability of fully charged battery packs, queue for charging, and so on. Based on this information, the user can decide to either approach that charging station 104 or look for some other charging station 104 in the vicinity. If the user decides to approach that charging station 104, the user will be assigned a booth number. In the booth, the user will have the option to either charge the discharged battery pack 102 or replace the discharged battery pack 102 with a fully charged battery pack 102 in exchange for money, which can be paid either in cash, or via credit/debit cards or using any kind of digital wallets. In an embodiment, the payment for charged batteries is calculated by computing the difference in charges between the charged and discharged batteries. If a person wants to exchange a fully charged battery to a partly discharged battery, he or she could still do so, while paying the price which corresponds only to the difference in the charge. If for some reason the user decides to cancel the order, it can be done via application or the user can simply choose another station or a mobile battery station.

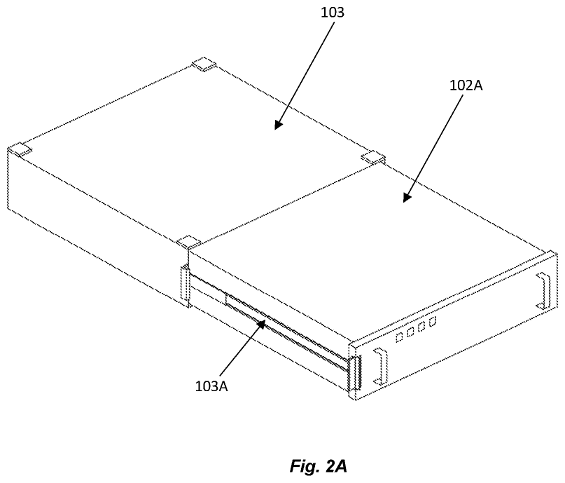

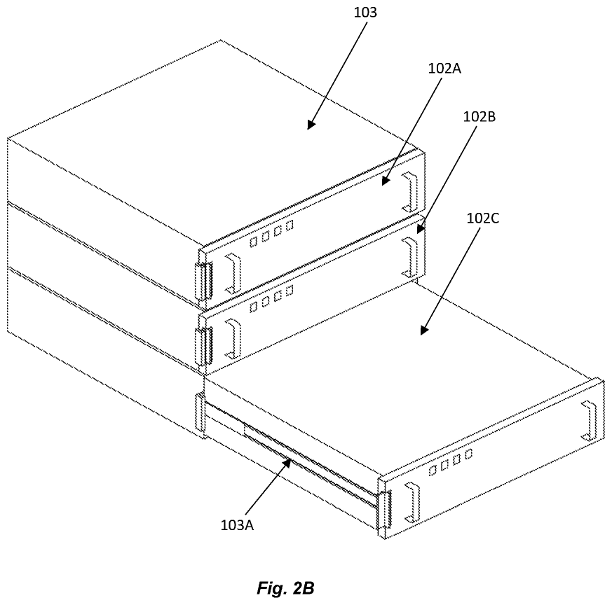

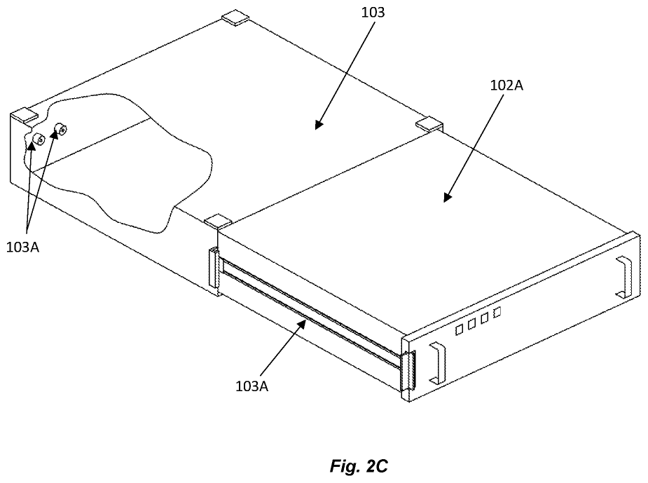

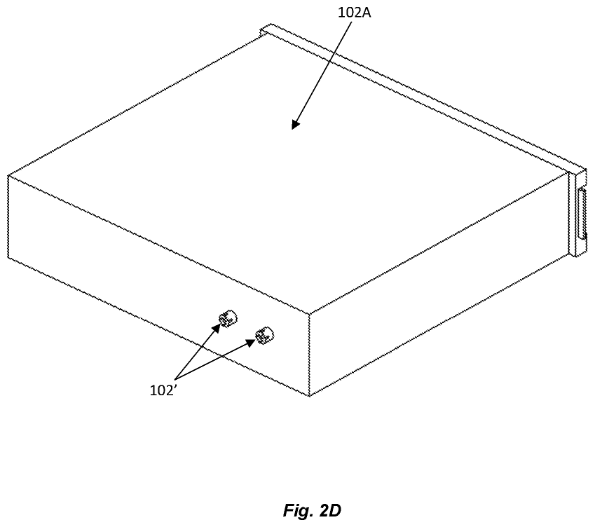

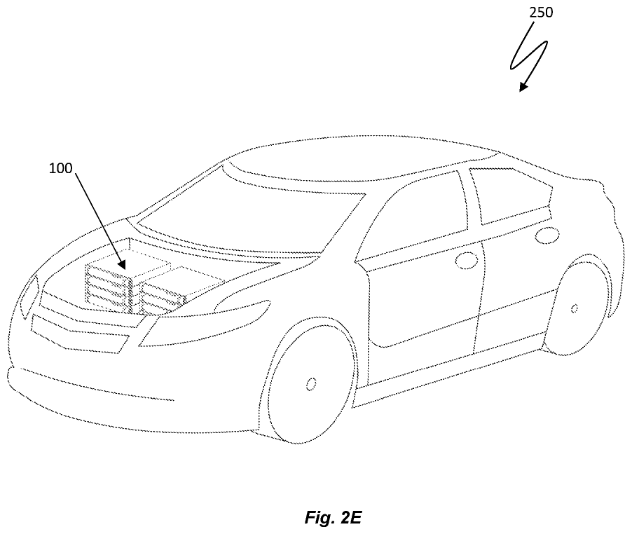

FIG. 2A through FIG. 2E illustrate isometric views of different components of the batter system 100. More specifically FIG. 2A illustrates an isometric view of a battery 102A and a battery rack assembly. The battery 102A is one of the many batteries present in the battery pack 102. The battery 102A is mounted in the battery rack 103. The battery rack 103 is a box having DIN rails 103A mounted therein. The battery 102A is mounted on the DIN rails 103A, and as such, are slidable within the battery rack 103.

FIG. 2B illustrates an isometric view of the battery pack 102 mounted on the battery rack 103. The battery pack 102 comprises a plurality of batteries 102A-102C. The battery rack 103 is configured to house the batteries 102A-102C.

FIG. 2C illustrates another isometric view of the battery 102A and the battery rack 103 assembly. As seen in FIG. 2C, the battery rack 103 has terminals 103B. These terminals 103B are configured to connect with the complementary terminals configured on the battery 102A. The complementary terminals 102′ on the battery 102A are seen in FIG. 2D, which is an isometric view of the battery 102A.

FIG. 2E illustrates an isometric view of a vehicle 250 in which the battery system 100 of the present invention is employed. As seen in FIG. 2E, the battery system 100 can be installed in the bonnet of the vehicle. In another embodiment, the battery system can be employed at an operative bottom portion of the vehicle 250. The position of the battery system 100 can be anywhere in the vehicle 250, and is not limited to the aforementioned embodiments.

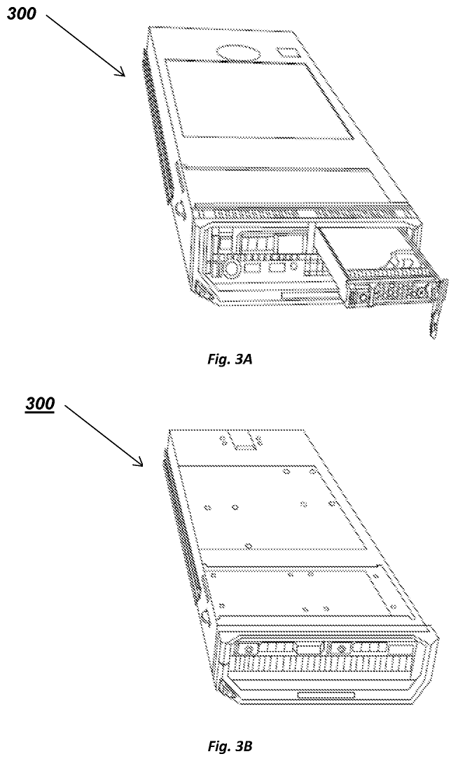

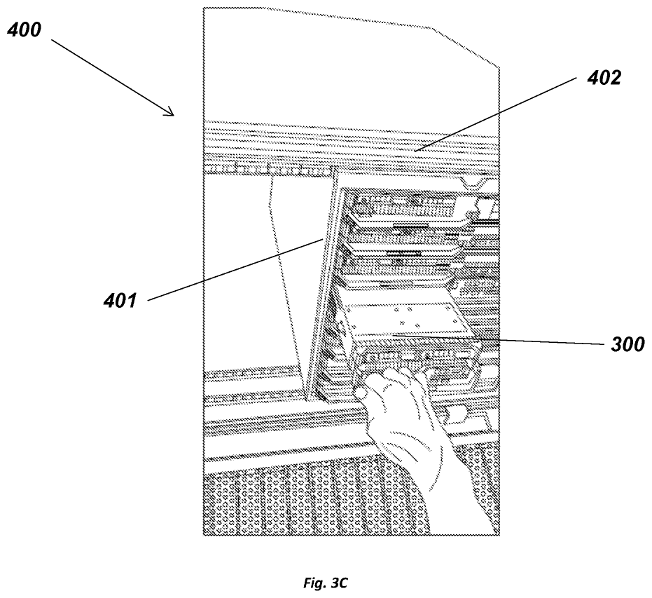

FIG. 3A to 3B illustrates different views of the universal battery module 300 with tracks. The each universal battery module is fitted into the case. The case has the tracks. The universal battery module 300 can easily slide in the tracks of the case. The universal battery module can be of different sizes. For one of the example, the universal battery module 300 has width of the module 110 mm, 220 mm, or 440 mm; depth of the module 300 mm to 600 mm; and height of the module can be 43 mm, 56 mm, 75 mm, 88 mm or 110 mm. FIG. 3C illustrates the perspective view of the universal battery system. The universal battery system 400 comprises different elements. Each one of the universal battery module 300 is fitted in the case. Then several fitting cases of the universal battery module 300 form a division 401 of the universal frame 402. Further, several sizes of the universal battery system 400 are available in the market. The universal battery system is designed such a way that all the universal battery module fitted in the system can be charged. The universal frame 402 fits in to the battery rack in the charging station. Further, part or full size universal frame can be fitted to any vehicle to put one or several battery modules. For bigger vehicles like Trucks: instead of replacing each universal battery module separately, one can one can replace universal battery pack with the frame which will be much quicker. Truck will have several racks to accept the universal frames.

The Universal battery module 300 sizes could be any of the following sizes, but not limited to this.

| Sizes | Capacity |
|---|---|
| Height 42 mm, Width 110 mm, | minimum 2 KwH, Minimum |
| Length 500 mm to 600 mm | Discharge current: (50 A); |
| | Minimum Peak Discharge |
| | current: (100 A) |
| Height 55 mm, Width 110 mm, | minimum 3 KwH, Minimum |
| Length 500 mm to 600 mm | Discharge current: (75 A); |
| | Minimum Peak Discharge |
| | current: (150 A) |
| Height 72 mm, Width 110 mm, | minimum 4 KwH, Minimum |
| Length 500 mm to 600 mm | Discharge current: (100 A); |
| | Minimum Peak Discharge |
| | current: (200 A) |
| Height 110 mm, Width 110 mm, | minimum 5 KwH, Minimum |
| Length 500 mm to 600 mm | Discharge current: (125 A); |
| | Minimum Peak Discharge |
| | current: (250 A) |
| Height 42 mm, Width 220 mm, | minimum 4 KwH, Minimum |
| Length 500 mm to 600 mm | Discharge current: (100 A); |
| | Minimum Peak Discharge |
| | current: (200 A) |
| Height 55 mm, Width 220 mm, | minimum 6 KwH, Minimum |
| Length 500 mm to 600 mm | Discharge current: (150 A); |
| | Minimum Peak Discharge |
| | current: (300 A) |
| Height 72 mm, Width 220 mm, | minimum 8 KwH, Minimum |
| Length 500 mm to 600 mm | Discharge current: (200 A); |
| | Minimum Peak Discharge |
| | current: (400 A) |
| Height 110 mm, Width 220 mm, | minimum 10 KwH, Minimum |
| Length 500 mm to 600 mm | Discharge current: (250 A); |
| | Minimum Peak Discharge |
| | current: (500 A) |

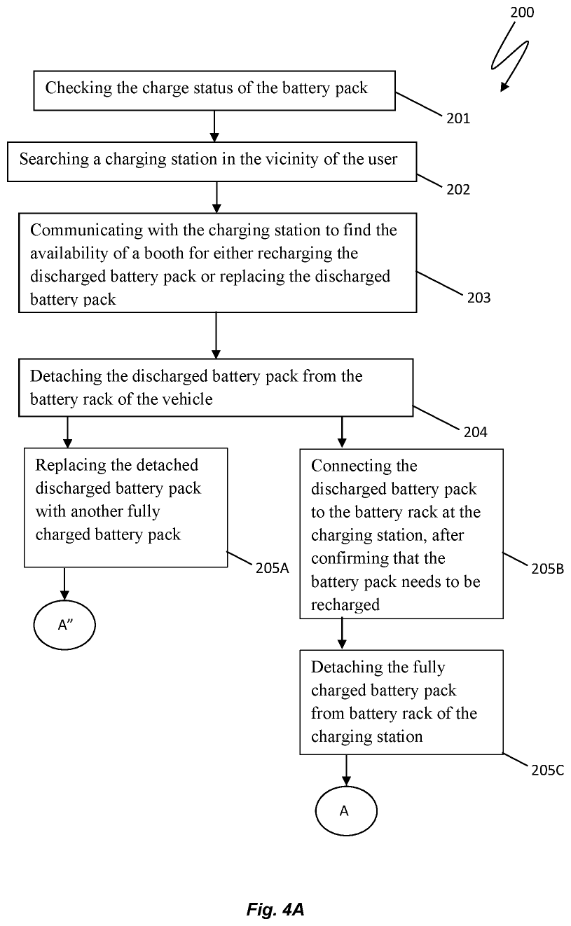

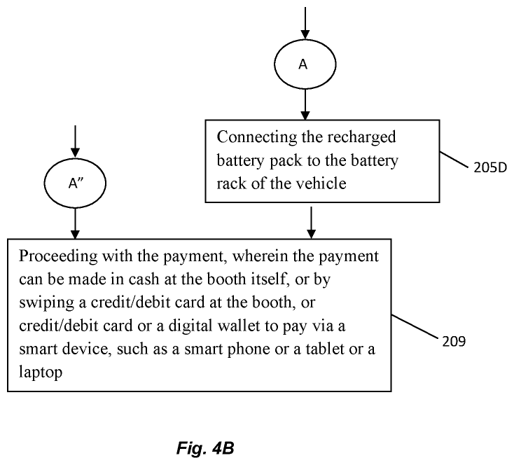

The present invention also envisages a method 200 for operating system 100, as illustrated in FIG. 4A and FIG. 4B. The order in which the method 200 is described is not intended to be construed as a limitation, and any number of the described method blocks can be combined in any order to implement the method or any alternative methods. Additionally, individual blocks may be deleted from the method without departing from the spirit and scope of the subject matter described herein. Furthermore, the method can be implemented in any suitable hardware, software, firmware, or combination thereof.

At block 201, the method includes the step of checking the charge status of the battery pack. At block 202, the method includes the step of searching a charging station in the vicinity of the user. The user can locate these fixed and Mobile battery stations through the apps and website in the mobile as well as in the Car dash. From the apps/website the user can see the position of the mobile and Stationary battery exchange system. Once the he user who is driving presses the button [to say that I need to exchange battery], any battery exchange station can press the button on their side to indicate that they are ready with the required number of batteries. Batteries can be exchanged manually or by use of Robot hands. The driver then can chose the one one station that is convenient to him and select that particular Battery exchange station [either stationary or Mobile] and move towards the station. The apps will direct the user towards the Station. The mobile battery station can move towards the user's Location. At block 203, the method includes the step of communicating with the charging station to find the availability of a booth for either recharging the discharged battery pack or replacing the discharged battery pack. At block 204, the method includes the step of detaching the discharged battery pack from the battery rack of the vehicle. At block 205A, the method includes the step of replacing the detached discharged battery pack with another fully charged battery pack. At step 205B, the method includes the step of connecting the discharged battery pack to the battery rack at the charging station, after confirming that the battery pack needs to be recharged. At step 205C, the method includes the step of detaching the fully charged battery pack from battery rack of the charging station. At step 205D, the method includes the step of connecting the recharged battery pack to the battery rack of the vehicle. At step 206, the method includes the proceeding with the payment, wherein the payment can be made in cash at the booth itself, or by swiping a credit/debit card at the booth, or credit/debit card or a digital wallet to pay via a smart device, such as a smart phone or a tablet or a laptop. The user can also prepay before coming to the exchange station. The user can also apply for an account; the user can apply for an “Energy Card” similar to certain shopping cards and they can purchase the “current” from it.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

The foregoing disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

We claim:

1. A battery system comprising:
a battery pack comprising a plurality of batteries;
at least one charging station provided at strategic locations in a town; and
at least one battery rack for supporting said battery pack and electrically connecting with said battery pack either for charging or discharging, wherein:
for charging, said battery rack is provided at said charging station; and
for discharging, said battery rack is provided at end application setup.

2. The battery system as claimed in claim 1, further comprising an application module installable on at least one smart device of a user.

3. The battery system as claimed in claim 1, wherein said end application setup is an electric car or a hybrid car.

4. The battery system as claimed in claim 1, wherein said charging station is configured to generate power via renewable sources of energy.

5. The battery system as claimed in claim 2, wherein said charging stations are further comprises at least one GPS module.

6. The battery system as claimed in claim 5, wherein said application module is configured to allow said user to track the locations of said charging stations.

7. The battery system as claimed in claim 6, wherein said application module is configured to facilitate electronic payment either via bank account or digital wallets.

8. The battery system as claimed in claim 1, wherein said battery pack is ejectably mounted on said battery rack.

9. The battery system as claimed in claim 8, wherein said ejection is facilitated either manually or remotely.

10. The battery system as claimed in claim 2, wherein said charging stations include fully charged individual batteries or battery packs to be exchanged with discharged batteries at said end application setup.

11. The battery system as claimed in claim 10, wherein said application module is configured to compute payment based on difference in charge levels of the exchanged battery packs.

12. The battery system as claimed in claim 1, wherein said battery rack further comprises a battery management unit.

13. A method comprising:
checking the charge status of a battery pack;
searching a charging station in the vicinity of the user;
communicating with a charging station to find the availability of a booth for either recharging the discharged battery pack or replacing the discharged battery pack; and
detaching the discharged battery pack from a battery rack.

14. The method as claimed in claim 13, further comprising:
replacing the detached discharged battery pack with another fully charged battery pack;
connecting the discharged battery pack to the battery rack at the charging station, after confirming that the battery pack needs to be recharged;
detaching the fully charged battery pack from battery rack of the charging station;
connecting the recharged battery pack to the battery rack of the vehicle; and
proceeding with the payment, wherein the payment can be made in cash at the booth itself, or by swiping a credit/debit card at the booth, or credit/debit card or a digital wallet to pay via a smart device, such as a smart phone or a tablet or a laptop.
